(19) United States
(12) Patent Application Publication
(10) Pub. No.: US 2025/0335793 A1
(43) Pub. Date: Oct. 30, 2025

(54) System and Method for Communicating with Loved Ones

(71) Applicant: Evry Archer, JR., Brandon, FL (US)

(72) Inventor: Evry Archer, JR., Brandon, FL (US)

(21) Appl. No.: 18/650,322

(22) Filed: Apr. 30, 2024

(51) Int. Cl. G06N 5/025; G06F 16/438; H04L 51/02

(52) U.S. Cl. CPC G06N 5/025; G06F 16/4393; H04L 51/02

(57) ABSTRACT

A system and method for communicating with loved ones implemented on a computer gathers information about a person during and optionally after the life of the person, typically using artificial intelligence to collect and categorize the information into a knowledge base. Typically, after the passing of the person, another user receives access to the system (e.g., computer) and is provided with various interactions with the person, thereby simulating the persona and knowledge of the person in an attempt to communicate with the user (e.g., a family member), providing information of the person's life as captured above; providing a legacy of the person.

### FIELD OF THE INVENTION

This invention relates to providing an after-death experience to those left behind.

### BACKGROUND OF THE INVENTION

When someone close to you dies, there is often sadness, grief, pain, anger, and a host of other feelings. Some people are able to work through those feelings and move on through life as time often helps heal these wounds, but many have difficulty getting past these feelings and the sadness and pain linger for months or years.

People often surround themselves with momentums of those who have past, for example, pictures, rings, watches, letters, possessions of a loved one, audio speech, videos, etc. Some talk to these as if this loved one is still present. Many search for some sort of closure, trying to resolve prior problems or conflicts that never found closure, but without this loved one being present, closure is difficult to achieve. Escalating this, some seek a medium that will communicate with those who have passed. Sometimes, if the medium is good, the medium will provide sufficient information to increase credibility that a conversation is actually being made with the person who has passed and, if the medium is psychologically adept, the medium may be able to recognize the source of the pain and direct the conversation towards some level of closure. For example, if the medium recognizes that this person is having difficulty with having cheated on the person who passed, the medium might say, “he says he forgives you for cheating on him.” This might help this person move on. Although useful to some, most people are skeptical and do not believe you can really communicate with the dead.

Today, with modern neural networks and artificial intelligence, one can bring to life a machine that resembles a human being to some extent. For example, with some intelligence and voice recognition, several companies have provided devices for your home that activate upon recognition of a key phrase (e.g., “Alexa”) and respond to your questions. For example, “Alexa, what time is it?” will result in the device emitting audio of the current time. If asked, “Alexa, are you married?” will result in the device emitting audio saying why the device isn't married such as the device lives in the clouds, etc. Similar technology is now possible with video allowing video recreations of people, especially actors and actresses, often fooling people into believing those people actually performed in the video provided.

What is needed is a method and system that will train a learning system about a person while the person is alive, then after the person dies, permitting interaction with the system, hopefully to help reach closure.

### SUMMARY OF THE INVENTION

A system and method for communicating with loved ones is implemented on a computer and gathers information about a person during and optionally after the life of the person, typically using artificial intelligence to collect and categorize the information into a knowledge base. Typically, after the passing of the person, another user receives access to the system (e.g., computer) and is provided with various interactions with the person, thereby simulating the persona and knowledge of the person in an attempt to communicate with the user (e.g., a family member), providing information of the person's life as captured above; providing a legacy of the person.

In one embodiment, a method for communicating with loved ones includes initializing a knowledge base the, during a learning mode, receiving information about a person, processing the information into knowledge about the person, and storing the knowledge in the knowledge base. During a communications mode, the method includes extracting a portion of the knowledge from the knowledge base, processing the portion of the knowledge into an output format and outputting the output format.

In another embodiment, a system for communicating with loved ones includes a computer having a processor, a display, an audio transducer, and an input device. A persistent storage (e.g., local storage or cloud-based storage) is operatively coupled to the computer and accessible by the processor and a knowledge base is in the storage. The processor is configured to receive information about a person from the input device and to process the information using learning algorithms implemented with artificial intelligence to create knowledge about the person. The processor is also configured to store the knowledge in the knowledge base, forming a legacy for the person.

In another embodiment, a system for communicating with loved ones system includes a computer having a processor, a display operatively interfaced to the processor, an audio transducer operatively interfaced to the processor, and an input device operatively interfaced to the processor. There is a persistent storage operatively coupled to the computer and accessible by the processor and a knowledge base is stored in the persistent storage. Computer instructions are initially stored in the persistent storage and cause the processor to receive information about a person and to process the information using learning algorithms implemented with additional computer instructions configured to implement artificial intelligence, the computer instructions cause the processor to create knowledge about the person to store the knowledge in the knowledge base.

### BRIEF DESCRIPTION OF DRAWINGS

The invention can be best understood by those having ordinary skill in the art by reference to the following detailed description when considered in conjunction with the accompanying drawings in which:

FIG. 1 illustrates a data connection diagram of the system for communicating with loved ones who have passed.

FIG. 2 illustrates a schematic view of a typical smartphone.

FIG. 3 illustrates a schematic view of a typical computer system such as a server or personal computer.

FIGS. 4-9 illustrate smartphone user interface during learning mode of the system for communicating with loved ones who have passed.

FIGS. 10-13 illustrate smartphone user interface during communications mode of the system for communicating with loved ones who have passed.

FIG. 14 illustrates the operation of the system for communicating with loved ones who have passed during the learning mode.

FIGS. 15 and 16 illustrate operations of the system for communicating with loved ones who have passed during the communications mode.

FIG. 17 illustrates an exemplary implementation of the system for communicating with loved ones within which a mathematical process.

FIGS. 18-22 illustrate exemplary program flows of the system for communicating with loved ones who have passed.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures.

Throughout this description, the term person refers to the person who desires to leave a legacy using the system for communicating with loved ones. The term user refers to a person who desires to communicate with the system for communicating with loved ones, typically after the person has passed (e.g., interact with the person's legacy). The term “passed” refers to a person who had died or is otherwise incapacitated. The term learning mode refers to a mode of the system for communicating with loved ones during the life of the person in which knowledge about the person is gathered. The term, “communications mode,” refers to a mode of operation of the system for communicating with loved ones in which the user interacts with the system for communicating with loved ones to communicate with the person who has passed or is otherwise incapacitated.

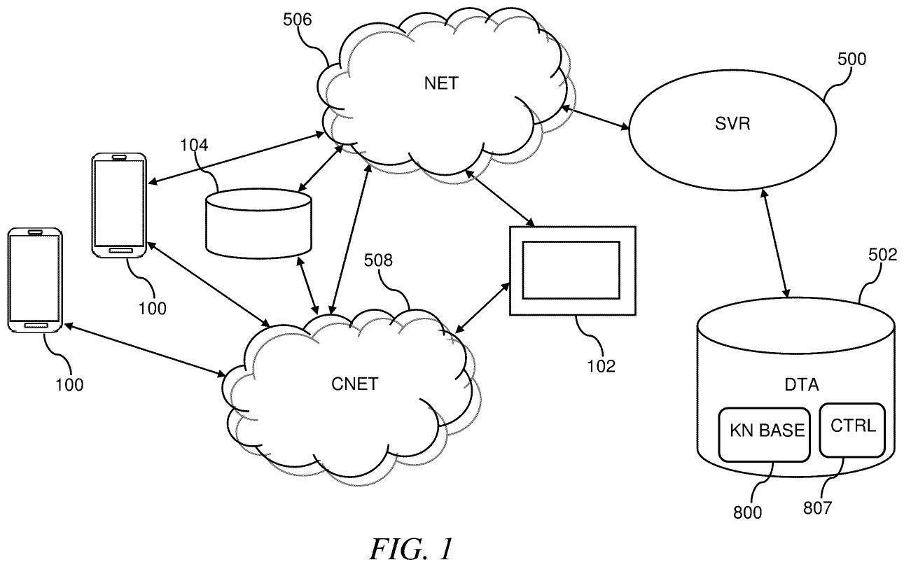

Referring to FIG. 1 illustrates an exemplary data connection diagram of the system for communicating with loved ones. In this example, one or more devices such as smartphones 100 and/or digital picture frames 102 communicate through the cellular network 508 and/or through a data network 506 (e.g. the Internet) to a server computer 500.

The server computer 500 has access to data storage 502 (e.g. “cloud” storage or local storage) that is used to store a knowledge base 800 and control files 807. As will be shown, the knowledge base 800 includes knowledge gained from the person during the life of the person (or after should a loved one manually update the knowledge based 800, for example, to make corrections). The control files 807 provide guidance to an application that gathers legacy knowledge from the person, for example, having a set of prompts and weights that help lead the person to provide a full set of legacy information. The control files 807 are used in the led mode of the application, providing prompts to request information from the person to complete the person's legacy (e.g., “where were you born?”). In some embodiments, even when the led mode is not in use, the control files 807 are consulted to help determine if key information about the person is missing. In this, artificial intelligence is used to process the knowledge base 800 with respect to one or more key data items as defined by the control files 807 and, if information is missing, the person is randomly prompted indicating that such missing information is important for their legacy. It is fully anticipated that each entry in the control files 807 be weighted as to importance with respect to a typical legacy. For example, the person's birthdate may have a low weight as many relatives will know the person's birthdate, but many might not know who went to Prom with the person, so the weight of this would be higher.

It is fully anticipated that the user interfaces, prompts, data, information, etc., be stored/inputted, displayed, and/or outputted in any language known.

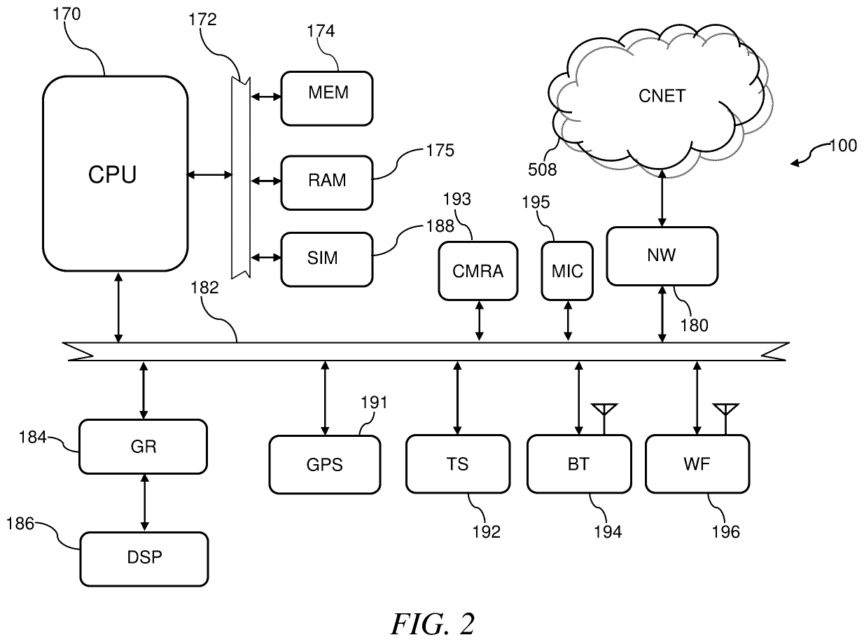

One path between the smartphones 100 and the server computer 500 is shown going through the cellular network 508 and the data network 506, any known data path is anticipated. For example, the Wi-Fi transceiver 196 (see FIG. 2) of the smartphone 100 is used to communicate directly with the data network 506, which includes the Internet, and, consequently, with the server computer 500.

The server computer 500 transacts with software running on the smartphones 100 through the network(s) 508/506. The software (e.g., an application) presents menus to/on the smartphones 100, provides data to the smartphones 100 and digital picture frames 102, and communicates information to/from the server such as images, video, and voice.

The server computer 500 transacts with an application running on the smartphones 100 and/or digital picture frame 102 as needed, for example, when learning from the user or outputting video or audio of the user. Although in this disclosure, a smartphones 100 and/or digital picture frame 102 is used as an example, any processor-based device is anticipated including, but not limited to, a personal computer, a tablet computer, and a smart watch. In some embodiments, an image of the person is displayed by the application while in some embodiments an icon (still or animated) is displayed (e.g., an animated teddy bear). In some embodiments, to provide extra comfort, the application is running on a processor-based device that is embedded within a stuffed animal such as a stuffed teddy bear, providing audio output through a transducer within the stuffed animal.

The system for communicating with loved ones stores knowledge of a user in the knowledge base 800 (e.g. in data storage 502 that is local to the server computer 500, cloud-based storage, etc.).

Referring to FIG. 2, a schematic view of a typical end-user device, a smartphone 100 is shown. Although any end-user device is anticipated such as personal computers, tablets, digital picture frames 102, for clarity purposes, a smartphone 100 will be used in the remainder of the description.

The system for communicating with loved ones is described using a processor-based end-user device (e.g., smartphone 100) for providing the login and interaction with user interfaces necessary for gathering knowledge of the person and communicating with a user (e.g., loved one) later. The present invention is in no way limited to using a smartphone 100 and any similar device is anticipated (e.g., cellular phone, portable digital assistant, tablet, notebook, smart watch, etc.).

The example smartphone 100 represents a typical device used for accessing user interfaces of the system for managing construction. This exemplary smartphone 100 is shown in its simplest form. Different architectures are known that accomplish similar results in a similar fashion and the present invention is not limited in any way to any particular smartphone 100 system architecture or implementation. In this exemplary smartphone 100, a processor 170 executes or runs programs in a random-access memory 75. The programs are generally stored within a persistent memory 174 and loaded into the random-access memory 175 when needed. Also accessible by the processor 170 is a SIM card 188 (subscriber information module) having a subscriber identification and often persistent storage. The processor 170 is any processor, typically a processor designed for phones. The persistent memory 174, random access memory 175, and SIM card are connected to the processor by, for example, a memory bus 172. The random-access memory 175 is any memory suitable for connection and operation with the selected processor 170, such as SRAM, DRAM, SDRAM, RDRAM, DDR, DDR-2, etc. The persistent memory 174 is any type, configuration, capacity of memory suitable for persistently storing data, for example, flash memory, read only memory, battery-backed memory, etc. In some exemplary smartphones 100, the persistent memory 174 is removable, in the form of a memory card of appropriate format such as SD (secure digital) cards, micro-SD cards, compact flash, etc.

Also connected to the processor 170 is a system bus 182 for connecting to peripheral subsystems such as a cellular network interface 180, a graphics adapter 184 and a touch screen interface 192. The graphics adapter 184 receives commands from the processor 170 and controls what is depicted on the display 186. The touch screen interface 192 provides navigation and selection features.

In general, some portion of the persistent memory 174 and/or the SIM card 188 is used to store programs, executable code, and data, etc. In some embodiments, other data is stored in the persistent memory 174 such as audio files, video files, text messages, etc.

The peripherals are examples and other devices are known in the industry such as Global Positioning Subsystem 191, speakers, microphones, USB interfaces, camera 193, microphone 195, Bluetooth transceiver 194, Wi-Fi transceiver 196, image sensors, temperature sensors, etc., the details of which are not shown for brevity and clarity reasons.

The cellular network interface 180 connects the smartphone 100 to the cellular network 508 through any cellular band and cellular protocol such as GSM, TDMA, LTE, 5G, etc., through a wireless medium. There is no limitation on the type of cellular connection used. The cellular network interface 180 provides voice call, data, and messaging services to the smartphone 100 through the cellular network 508.

For local communications, many smartphones 100 include a Bluetooth transceiver 194, a Wi-Fi transceiver 196, near-field transceivers, or any combination of such. Such features of smartphones 100 provide data communications between the smartphones 100 and data access points and/or other computers such as a personal computer (not shown).

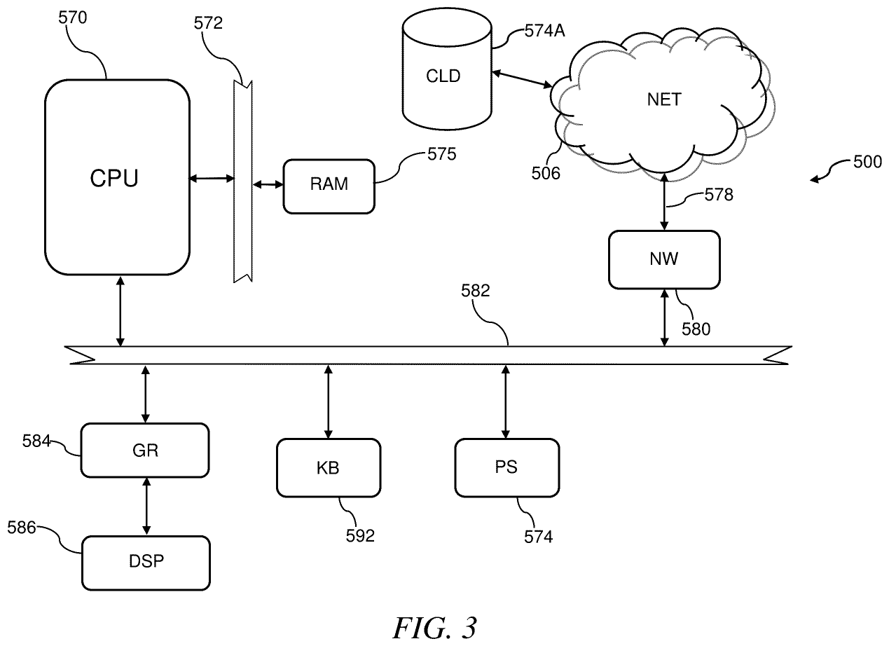

Referring to FIG. 3, a schematic view of a typical computer system (e.g., server computer 500) is shown. The example computer system (server computer 500) represents a typical computer system used for back-end processing, generating reports, displaying data, etc. This exemplary computer system is shown in its simplest form. Different architectures are known that accomplish similar results in a similar fashion and the present invention is not limited in any way to any particular computer system architecture or implementation. In this exemplary computer system, a processor 570 executes or runs programs in a random-access memory 575. The programs are generally stored within a persistent memory 574 and loaded into the random-access memory 575 when needed. The processor 570 is any processor, typically a processor designed for computer systems with any number of core processing elements, etc. The random-access memory 575 is connected to the processor by, for example, a memory bus 572. The random-access memory 575 is any memory suitable for connection and operation with the selected processor 570, such as SRAM, DRAM, SDRAM, RDRAM, DDR, DDR-2, etc. The persistent memory 574 is any type, configuration, capacity of memory suitable for persistently storing data, for example, magnetic storage, flash memory, read only memory, battery-backed memory, magnetic memory, etc. The persistent memory 574 (e.g., disk storage) is typically interfaced to the processor 570 through a system bus 582, or any other interface as known in the industry.

Also shown connected to the processor 570 through the system bus 582 is a network interface 580 (e.g., for connecting to a data network 506), a graphics adapter 584 and a keyboard interface 592 (e.g., Universal Serial Bus-USB). The graphics adapter 584 receives commands from the processor 570 and controls what is depicted on a display 586. The keyboard interface 592 provides navigation, data entry, and selection features.

In general, some portion of the persistent memory 574 is used to store programs, executable code, data, a knowledge base 800, and other data, etc. In some embodiments, persistent memory is provided through cloud storage 574A connected through the data network 506.

The peripherals are examples and other devices are known in the industry such as pointing devices, touch-screen interfaces, speakers, microphones, USB interfaces, Bluetooth transceivers, Wi-Fi transceivers, image sensors, temperature sensors, etc., the details of which are not shown for brevity and clarity reasons.

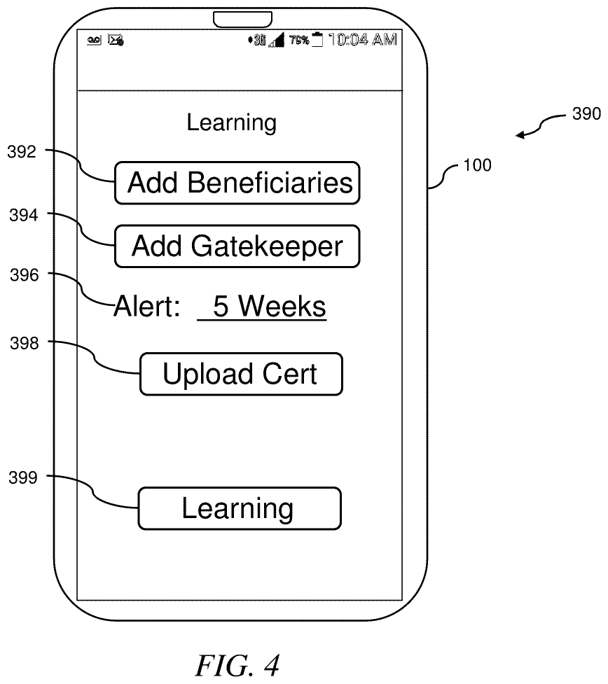

Referring to FIGS. 4-9, exemplary user interfaces of the system for communicating with loved ones are shown operating in the learning mode, learning information about the person. For brevity and clarity reasons, the login process for the person and for the user(s) is not shown as there are many login processes anticipated, requiring usernames, passwords, biological samples (e.g., fingerprints), secondary authentication, knowledge of pre-entered facts (e.g., first school name), etc. In general, it is assumed that the person or user is already logged in throughout the remainder of this description.

In FIG. 4, after logging in, the person has several options to select in an initial user interface 390. The first option is for adding beneficiaries 392. Selecting the add beneficiaries option allows the person to add users that will gain access to the system for communicating with loved ones at a certain time, presumably after the person passes or is otherwise incapacitated. In this, the person adds information about each beneficiary (user) such as name, phone number, email address, address, etc. In this way, upon receiving notification of the person passing, the system for communicating with loved ones is able to reach out to the beneficiaries (users) to inform them that they can now visit the person's legacy, if desired.

There is a second directive for adding a gatekeeper 394. selecting the add gatekeeper option allows the person to add a user (or superuser) that will have at least limited access to the system for communicating with loved ones before the person passes or is otherwise incapacitated. In this, the person adds information about the gatekeeper such as name, phone number, email address, address, etc. In this way, the gatekeeper has at least limited access to the system for communicating with loved ones, for example, for uploading a death certificate to enable access by the beneficiaries (uses).

There is a third directive for alerting 396 due to non-access. In some embodiments, the users (e.g. beneficiaries) are activated upon providing certain documents to the system for communicating with loved ones, for example, a death certificate or certification of incapacity). In some embodiments, the person is able to initiate the same after logging in or after not using the system for communicating with loved ones for a specified period of time (e.g., five weeks in this example). In such, if the person does not log into the system for communicating with loved ones for the stated period of time, the users (e.g., beneficiaries) will receive messages from the system for communicating with loved ones providing information for accessing the person's legacy.

There is a fourth directive for uploading a certification 398, typically used by the gatekeeper to upload a death certificate or certificate of incapacity of the person. Upon uploading of the certification 398, the system for communicating with loved ones initiates a review of the certification 398 and, if correct, the system for communicating with loved ones provides information for accessing the person's legacy to the users (beneficiaries).

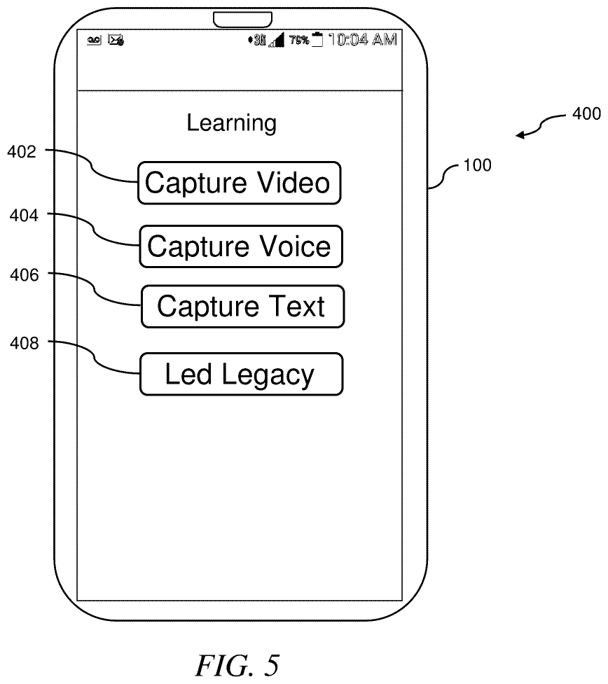

There is a fifth directive for entering the learning mode 399 of the system for communicating with loved ones. Invoking of this directive will present learning user interfaces, as for example, those shown in FIGS. 5-9.

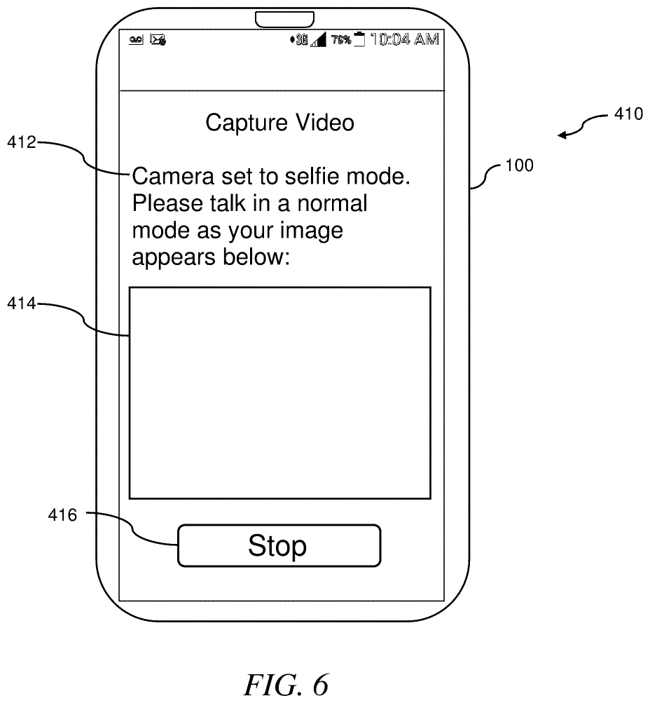

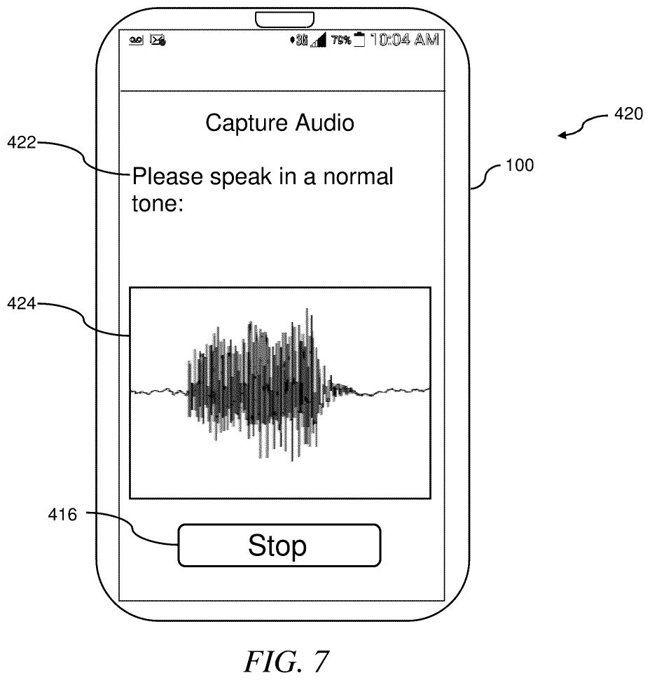

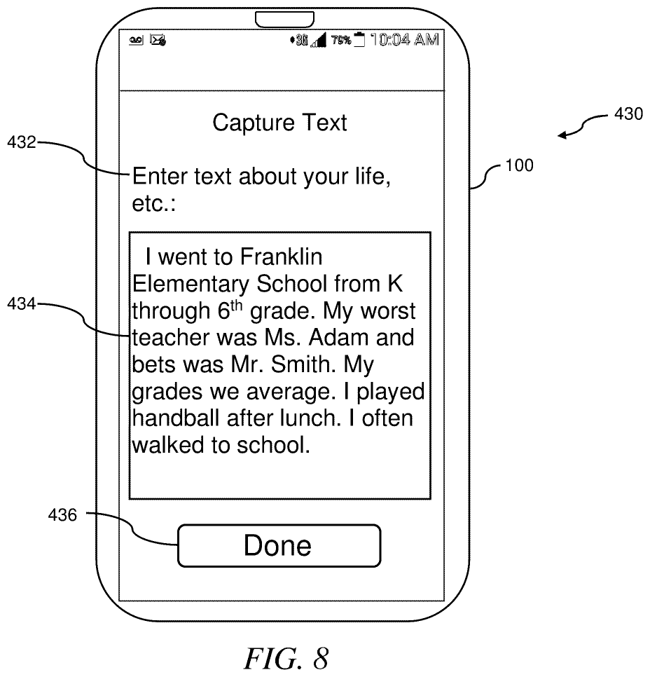

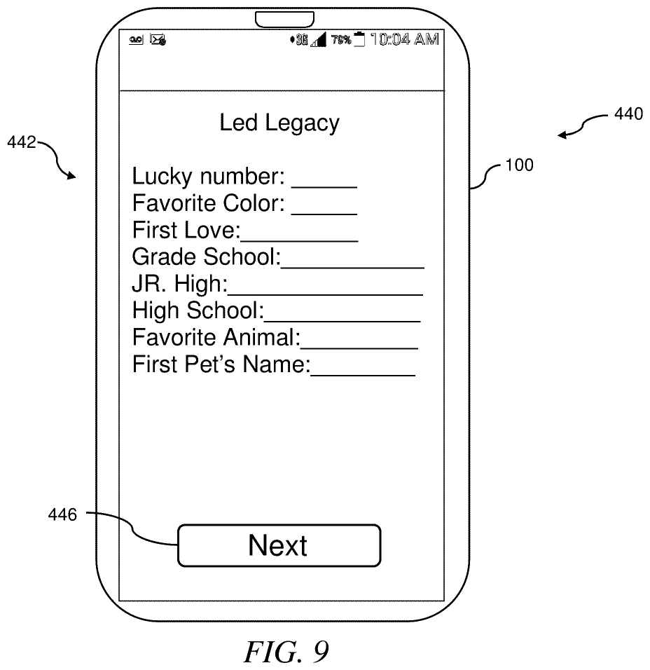

Referring to FIG. 5, a high-level learning mode user interface 400 is shown. In this, the person has various directives on how they want to provide data to the system for communicating with loved ones including a capture video directive 402, capture audio directive 404, capture text directive 406 and a “led legacy” directive 408. Selecting the capture video directive 402 will initiate a user interface such as the capture video user interface 410 of FIG. 6. Selecting the capture audio directive 404 will initiate a user interface such as the capture audio user interface 420 of FIG. 7. Selecting the capture text directive 406 will initiate a user interface such as the capture text user interface 430 of FIG. 8. Selecting the “led legacy” directive 408 will initiate a user interface such as the led legacy user interface 440 of FIG. 9. Note that it is fully anticipated that the “led legacy” be performed interactively with text prompts, audio prompts, text answers, audio answers, and/or video. For example, a voice prompt of “where did you go to high school” and a response from the person of “I went to high school at Union High.”

Referring to FIG. 6, a capture video user interface 410 is shown. In the capture video user interface 410, video instructions 412 are optionally provided, telling the person what to do. In some embodiments, the camera of the smartphone 100 is changed to selfie mode and the image of the person appears in a video box 414 and is captured until the person invokes the stop directive 416.

Referring to FIG. 7, a capture audio user interface 420 is shown. In the capture audio user interface 420, audio instructions 422 are optionally provided, telling the person what to do. In some embodiments, the audio received from the person is graphically presented in an audio box 424 and is captured until the person invokes the stop directive 416.

Referring to FIG. 8, a capture text user interface 430 is shown. In the capture text user interface 430, there are optionally text instructions 432 and the person enters information into a text entry box 434 until the person selects the done directive 436. All text entry is parsed and provided to software that analyzes the data and updates the knowledge base 800 from the data. In the example of FIG. 8, pieces of information such as the person's schools, teachers, and activities are added to the knowledge base 800. Note that in some embodiments, any or all of the learning user interfaces provide for error correction. For example, if the person says one thing in the capture audio user interface 420 (e.g., says “I went to college at Columbia”) then enters text in the capture text user interface 430 (e.g., enters “I went to college at Monmouth College”), the system for communicating with loved ones will note the issue and allow for correction.

Referring to FIG. 9, a led legacy user interface 440 is shown. The led legacy user interface 440 presents prompts 442 (shown in text form in FIG. 9, though audio prompts with audio responses or audio-video responses are equally anticipated). By leading the person through a series of prompts and answers, the system for communicating with loved ones will direct the user to provide information that will be of interest to users (e.g., beneficiaries) after the person has passed, often tidbits of information that the users might not know about the person such as personal preferences (e.g., colors, numbers), childhood activities, how the person thinks about certain events, things the person would have liked to do (e.g., travel to Italy), names of friends, vehicles, homes, collectable items, old technology (e.g., “my first phone was a rotary dial phone”). By leading the person through text or voice prompts and receiving responses by text or voice input, these tidbits of information are captured, parsed, and added to the knowledge base 800. The person is able to visit and revisit the led legacy user interface 440 as often as desired. Each time, the led legacy user interface 440 presents unanswered prompts or new prompts to provide entertainment and reduce the tedium of entering much of this data. The next directive 446 provides further prompts 442 for capturing still further legacy information.

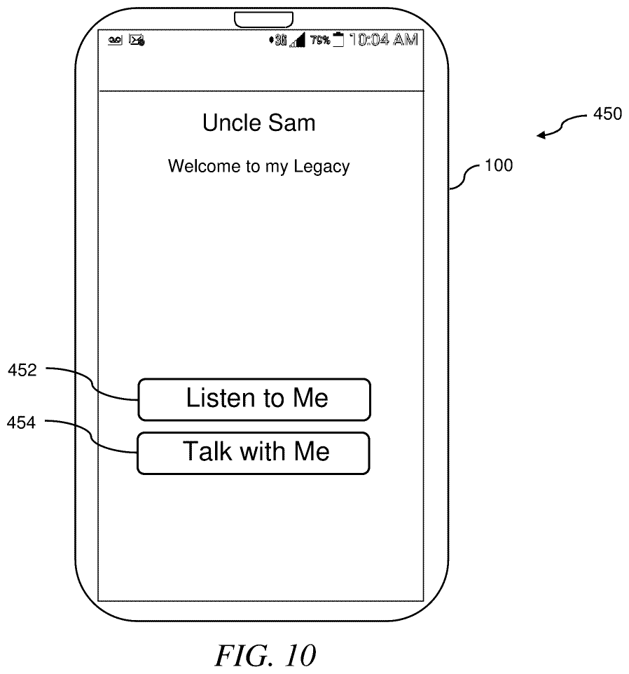

Referring to FIGS. 10-13, exemplary user interfaces of the system for communicating with loved ones are shown operating in the communications mode, perhaps after the person has passed. Once the person has passed, the system for communicating with loved ones translates into a communications mode in which each user (e.g., beneficiaries or loved ones) has login access to the person's legacy as described above. Although many user interfaces and formats are anticipated, including audio-led user interfaces (e.g., through a digital assistant), the user interfaces shown a text based with text, audio, and/or video output capabilities.

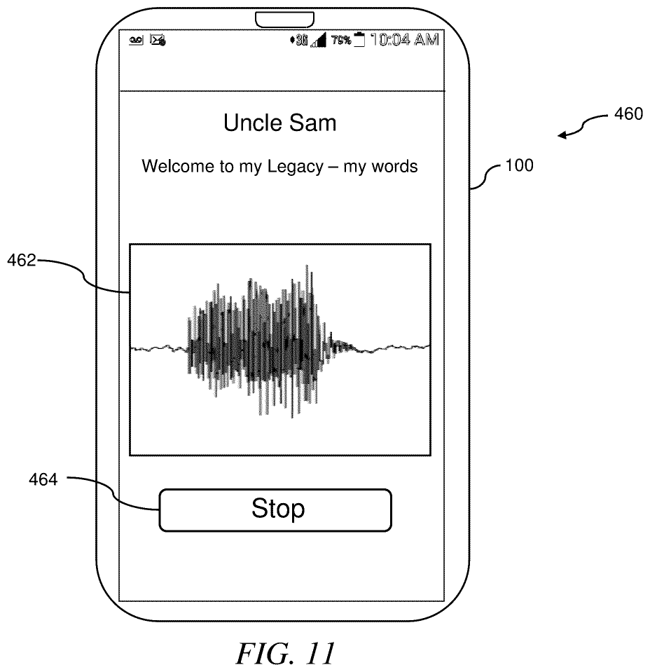

In FIG. 10, the first communicate user interface 450 provides directives for the user to listen 452 to the person (who has died) or to talk 454 with the person. Selecting the listen 452 directive presents a listen user interface 460 as in FIG. 11 in which the voice of the person is played back through an output device of the smartphone 100 or of digital picture frame 102 optionally including images or video displayed on a display of the smartphone 100. In some embodiments, a graphical depiction of the audio 462 is displayed. When done, the user evokes the stop feature 464 and audio stops.

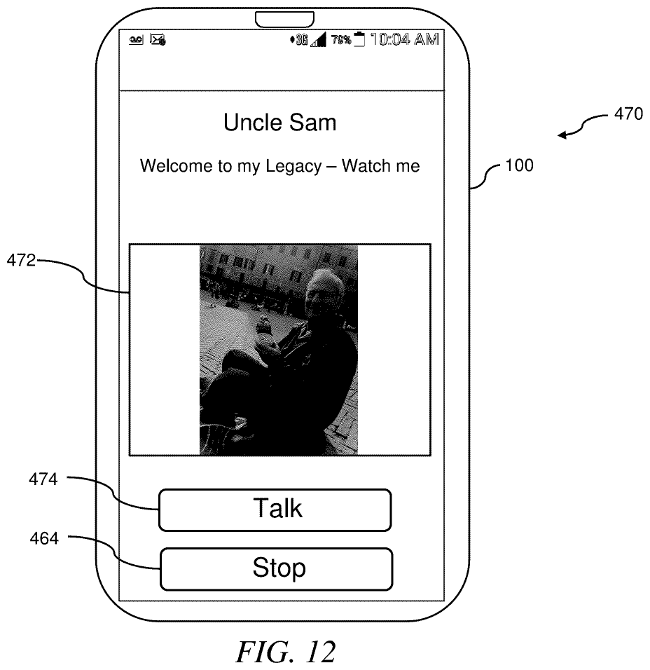

In FIG. 12, the watch user interface 470 provides directives for the user to watch (e.g., video) the person (who has died) or to talk with the person. Selecting the talk 454 directive presents an interactive user interface 470 in which the image/video 472 and/or voice of the person is played back through an output device and/or display of the smartphone 100 or of the digital picture frame 102.

In some embodiments, the ability to interact with the person is provided, either automatically or by selecting the talk 474 directive. In this, the user is able to talk to the person through an input device of the smartphone 100, digital picture frame 102, or digital assistant 104. The voice of the user is recognized and parsed and fed into the neural network to solicit a response from the person by way of the knowledge base 800. For example, if the user asks if the person went to college, the audio and video of the person might emit “yes, I went to Monmouth College in 1976 . . . ” In this way, the user is able to interact with the knowledge base as if the user was interacting with the person. The more information that is captured from the person during the learning mode and stored in the knowledge base 800, the more real the presentation of the person will be during communications mode, including realistic mannerisms, speech, expressions, colloquialisms, etc. This may be convincing that the user is actually communicating with the person who has passed.

When done, the user evokes the stop feature 464 and audio stops.

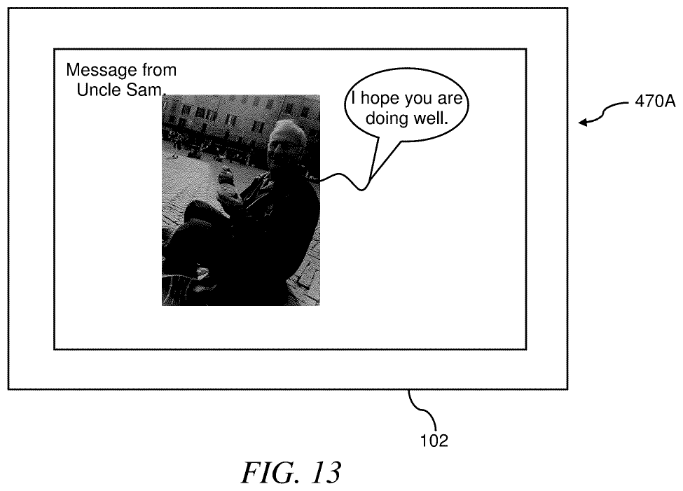

In FIG. 13, the watch user interface 470A provides output for the user to watch (e.g., video) the person (who has died). Selecting the watch 454 directive presents a watch user interface 470A in which the image/video and/or voice of the person is played back through an output device and/or display of the digital picture frame 102 which often has no input mechanisms.

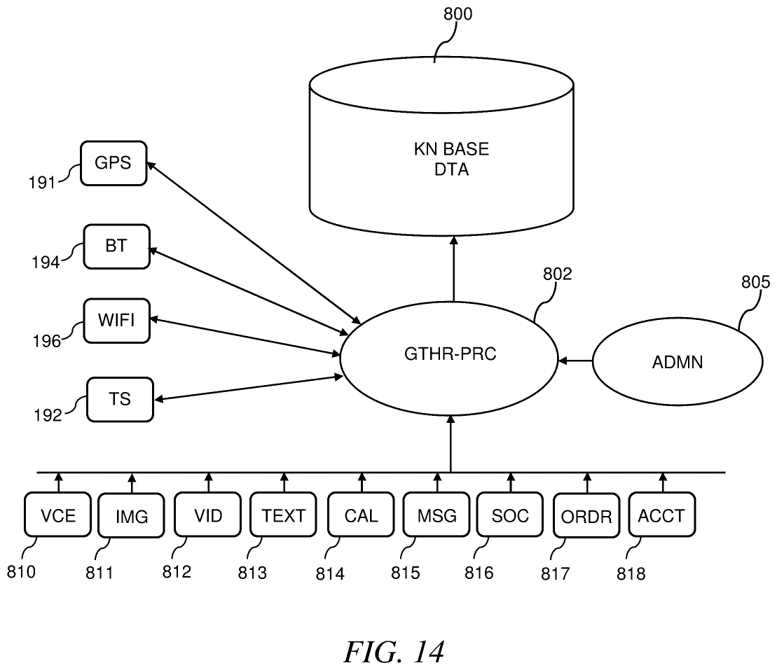

Referring to FIG. 14, a schematic diagram of the system for communicating with loved ones operating in the training mode is shown. In the learning mode, a gathering process 802 of the system for communicating with loved ones monitors/reads one or more input devices and receives voice input 810, images 811, video 812, text 813, calendar entries 814, messages 815, social network feeds 816, online ordering information 817, account information 818 (e.g., money movement), etc. For example, by monitoring the person's calendar, the system for communicating with loved ones is able to gather information as to the person's daily activities, important dates, travel, etc. By monitoring the person's text messages, the system for communicating with loved ones is able to obtain information about the person's frame of mind, likes, dislikes, friends, etc. In some embodiments, the Global Positioning System 191 (GPS/GNSS) receivers is monitored to track the person's location throughout the day and, when traveling, to log locations to which the person has traveled and durations. In some embodiments, the Wi-Fi transceivers 196 and/or cellular network transceivers 80 are monitored to determine location and control of certain appliances (e.g., when lights are turned on or off). In some embodiments, Bluetooth transceivers 94 is modified to determine access to certain devices such as televisions or wireless headphones. In some embodiments, direct access to the touch screen interface 92 provides data during the learning mode about how the person interacts with the smartphone 100, for example, is their touch steady, constant, declining, are they left or right-handed, etc. The learning mode is anticipated to be executed as an iterative process during the life of the person, starting at whatever age the person decides to leave their legacy using the system for communicating with loved ones. As the gathering process 802 extracts information (e.g., facts, inferences, audio segments, video segments, images), the gathering process 802 updates the knowledge base 800 for use by the communications mode processing module 820 after the person passes and the communications mode begins.

For privacy and security reasons, there is an administrative function 805 that provides the person with features that disable the learning mode when desired so as to not capture knowledge that the person does not want to have in their legacy. Further, the administrative function 805 also provides for editing and deletion of knowledge should unwanted information make it into the knowledge base 800. Note that in some embodiments, the administrative function 805 provides for editing of the knowledge base 800 by a user after the person passes, for example, for changing data that is sensitive or incorrect.

Once sufficient information is captured and stored in the knowledge base 800, communications mode is possible, but not necessarily automatically changed as the person is still living and it is anticipated that as long as the person lives (or possibly after death), further information is captured and stored in the knowledge base 800. The administrative function 805 has settings to change back and fourth between the learning mode and communications mode, though it is anticipated that during the learning mode, the person is able to use the communications mode to see what a user might see in the person's legacy.

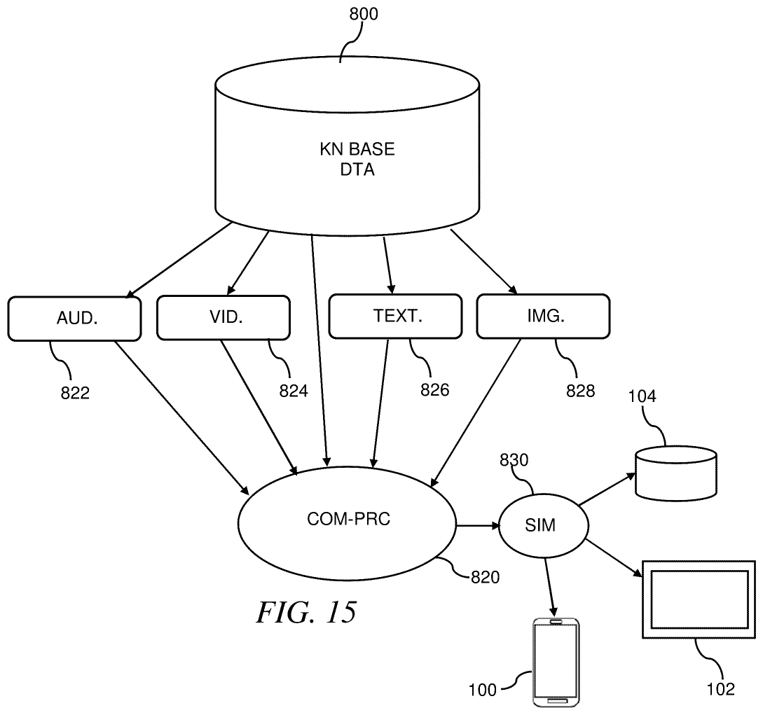

Typically, after the person passes, the communications mode is entered as shown in FIG. 15. In this, the knowledge base 800 along with audio segments 822, video segments 824, text segments 826, and images 828 are accessed by the communications mode processing module 820. The communications mode processing module 820 uses the learned information in conjunction with audio segments 822, video segments 824, text segments 826, and images 828 to generate content (e.g., recreated discussions from the person, facts, etc.) and feeds the simulation process 830. The simulation process 830 presents the content on any device capable of recreating the content, including a smartphone 100, a digital picture frame 102, and a digital assistant 104. Further anticipated is holographic output in which a simulation of the person appears in three dimensions.

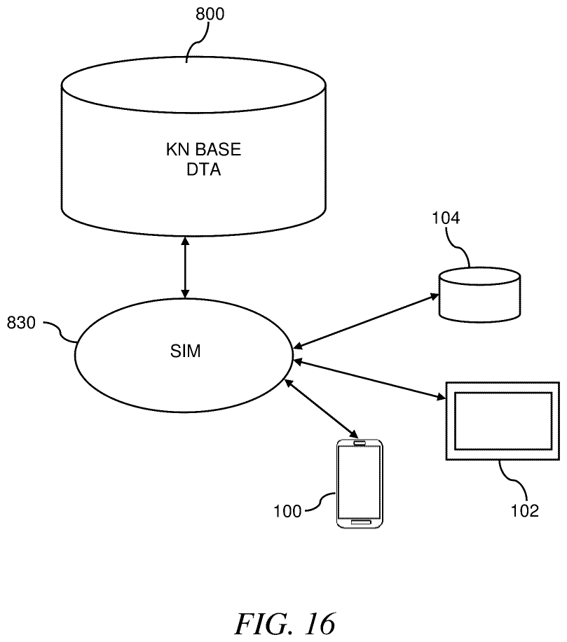

Referring to FIG. 16, the simulation process 830 is in duplex communications with one or more devices (e.g., a smartphone 100, a digital picture frame 102, and/or a digital assistant 104). In such, the simulation process 830 receives inputs from the devices such as commands (from voice or other input devices such as touch screens, keyboards, and mice) that control the simulation and allow the user to communicate with the legacy of the person, for example to ask questions or converse with the legacy. For example, asking the question “what college did you attend” will result in an answer such as “I went to Monmouth College” spoke in the person's voice as trained during the learning mode and captured in the knowledge base 800. Having the duplex communications provides the ability for the user to interact with the legacy of the person, possibly to the extent that the user will start to believe that they are communicating with the person. It is anticipated that safeguards be implemented to protect the user from emotional distress, for example, using a camera or microphone of one of the devices to detect this distress and stop the communications and/or emitting a message (not in the person's voice) that the user should seek professional advice.

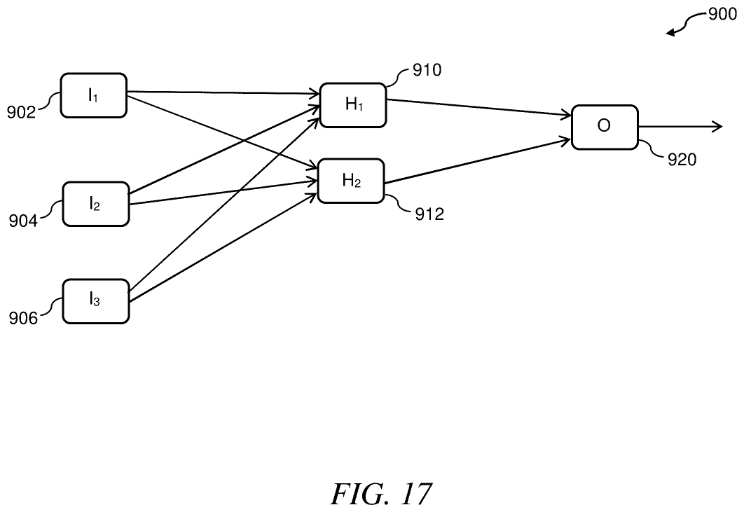

Referring to FIG. 17, an exemplary implementation of the learning process within which a mathematical process 900 represented by a simplified multilayer feed forward neural network is depicted. During a learning process, iterative sampling of input devices 810/811/812/813/814/815/816/817/818/93/95, Global Positioning System (GPS/GNSS) receivers 91, Wi-Fi transceivers 96, cellular network transceivers 80, Bluetooth transceivers 94 are processed by the neural network in the training mode over a period of sufficient duration to, in effect, learn the sensory input values. For each iteration, input values are fed into neurons 902/904/906 with adjustments being made to weights and biases of hidden neurons 910/912 based on deviations between the output value of the output neuron 920 and desired sample output. The iterative process is repeated using newly captured sensory inputs with continued refinements by use of error function feedbacks being applied to hidden neuron weights and biases. After the multi-iteration cycle the accumulated hidden neuron weights and biases are saved to a knowledge base 800 as a dataset aligned to time such that the collection of saved datasets represents a timeline of sensory sampling events.

Each embodiment of the invention implements support of a plurality of human inputs/outputs suitable to meet the requirements of reliable and accurate portrayal of information provided to the knowledge base 800.

As explained, each learned event dataset contains information related to a first mathematical process in a form and format suitable to provisioning a second mathematical process like that of the one used to create the data of the dataset. However, newly acquired information input to the second mathematical process produce a second value output indicative of likeness of the second value to the value employed to create the knowledge base 800.

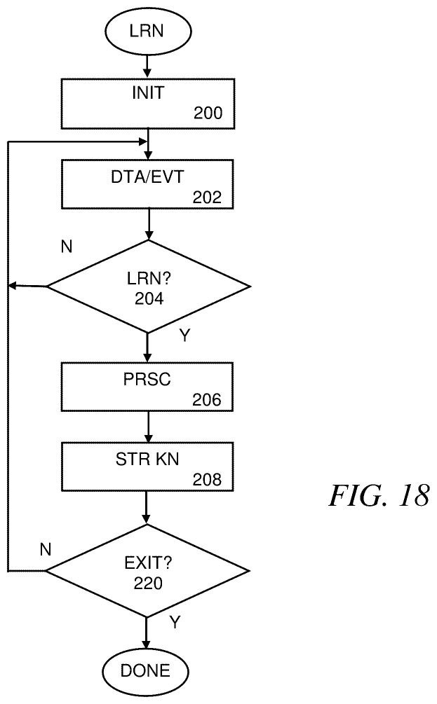

Referring to FIG. 18, an exemplary program flow during the during learning mode of the system for communicating with loved ones is shown. As discussed, during the learning mode, the knowledge base 800 is populated with data such as information of the person, statements by the person, images, video clips, etc. The learning mode is anticipated to run any length of time while the person lives to capture this data in the knowledge base 800 which will later be the person's legacy. It is fully anticipated that the learning mode be switchable, allowing for the person to shut off learning when desired. In this exemplary program flow, the learning mode starts with initializing 200 the knowledge base 800 to be ready to accept information regarding the person to form the person's legacy.

After initialization, data and events 202 are captured (in a loop) from the person by various input mechanisms, including voice input, voice input and recognition, camera input, text input, retrieval of specific images/video (e.g., finding images of the person in storage), extracting information from other files, inputs indicating a location of the person (e.g., the person is in Rome today), extracting information from communications (e.g., the person's boss sent a message of praise), etc. Each time for system for communicating with loved ones receives data or events 202, there is an opportunity to include the data or event 202 in the knowledge base 800, but not when the person wants privacy. Therefore, when the learning is off (prohibited) 204, the data or events 202 are not recorded in the knowledge base 800 and the loop continues.

When the learning is on (enabled) 204, the data or events are processed 206 (e.g., parsed, recognized, analyzed, simplified) and then are stored 208 in the knowledge base 800 as part of the person's legacy. If the person doesn't indicate they are done, the loop continues. If the person indicates that they want the application to exit 220, the application closes files and exits.

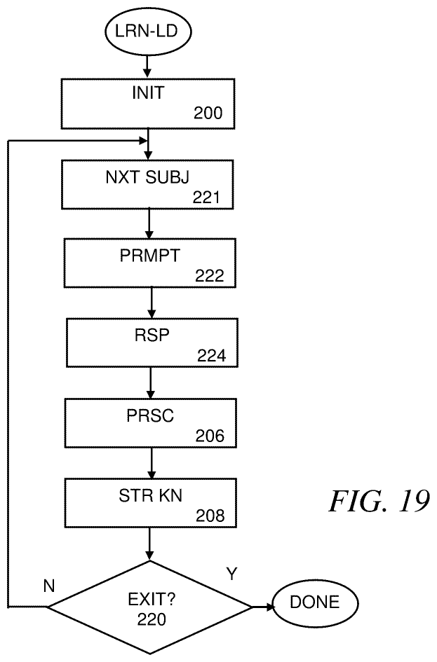

Referring to FIG. 19, an exemplary program flow during the during led learning mode of the system for communicating with loved ones is shown. As discussed, during the led learning mode, the system for communicating with loved ones leads the person to divulge certain information that is important to the person's legacy and the knowledge base 800 is populated with data. It is fully anticipated that the led learning mode be switchable, allowing for the person to shut off learning when desired. In this exemplary program flow, the learning mode starts with initializing 200 the knowledge base 800 to be ready to accept information regarding the person to form the person's legacy.

After initialization, a subject is selected 221. In some embodiments, the subject is selected from a set of subjects that are stored in the control files 807. In some embodiments, the existing data in the knowledge base 800 is first checked to determine if information regarding the subject was previously captured and, if so, that subject is marked so not to be selected again. In some embodiments, each subject has a weighting factor so that during the selection, subjects that are more important to a legacy are fulfilled first. Next, the person is prompted 222 with the subject (e.g., a text prompt, voice prompt, animated video prompt)—for example, “what is the name of the person that accompanied you to your high school prom?”

The response 224 from the person is received and processed 206 and stored 208 in the knowledge base as above. Until the person exits 220, that above steps are repeated. When the person is done being led with responses, the person indicates that they want to exit 220 and the led learning mode ends. The responses are captured from the person by various input mechanisms, including voice input, voice input and recognition, camera input, text input, selection of specific images/video, selection of information from other files, etc.

When the learning is on (enabled) 204, the data or events are processed 206 (e.g., parsed, recognized, analyzed, simplified) and then are stored 208 in the knowledge base 800 as part of the person's legacy. If the person doesn't indicate they are done, the loop continues. If the person indicates that they want the application to exit 220, the application closes files and exits.

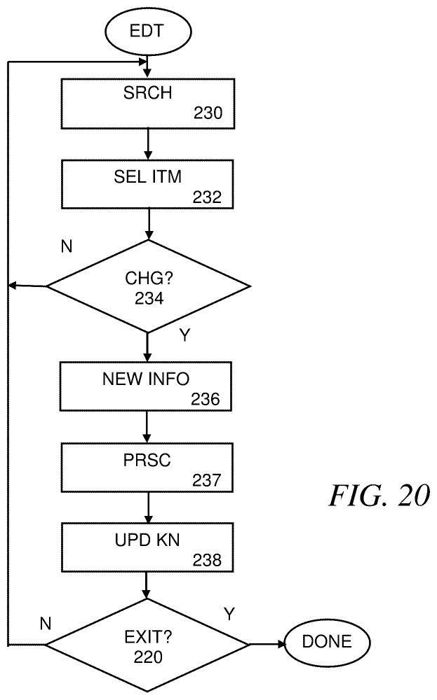

Referring to FIG. 20, an exemplary program flow for modifying the knowledge base 800 of the system for communicating with loved ones is shown. It should be noted that as information about the person is captured in the knowledge base 800 by the system for communicating with loved ones, the possibility of unwanted information or errant information is anticipated. For example, if the system for communicating with loved ones listens to the person and mis-interprets a piece of information (e.g., the person say they are blue and the system for communicating with loved ones makes a literal interpretation that the person is actually blue). For this, a edit function is provides as per FIG. 20, though it is fully anticipated that the edit function be embedded in the learn mode (e.g., the person inputs or says, “I need to change my time of birth from 8 AM to 8 PM).

In FIG. 20, the person (or user) performs a search 230 for the information that they want to change, for example, “what do you have as my time of birth?”). The person (or user) then selects 232 an item of information that is returned (e.g., multiple datum is returned for some search criteria). If the person (or user) wants to change 234 the information that was selected 232, the user provides 236 the new information (e.g., by typing or speaking) and the new information is processed 237 and the knowledge base 800 is updated 238 with the new information.

This repeats until the person (or user) exits 220.

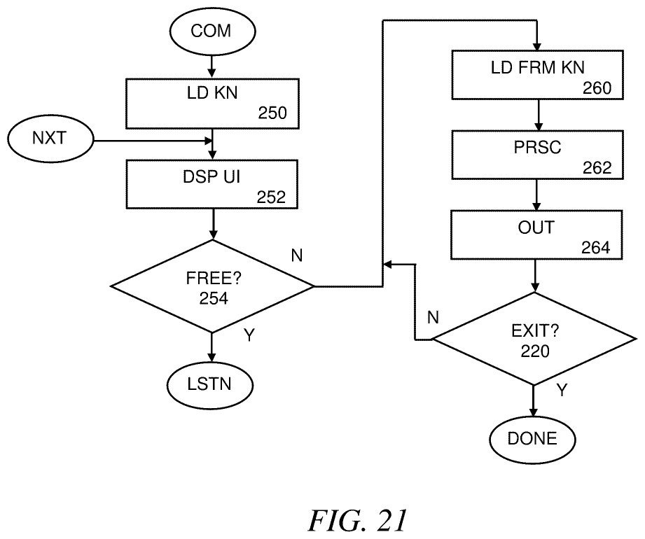

Referring to FIG. 21, an exemplary program flow for communicating the system for communicating with loved ones is shown. Although the communications mode is most often used by a user after the person has passed, it is fully anticipated that the person enters communications mode to review their legacy at any time.

In FIG. 21, the knowledge base 800 is loaded 250 and, in a loop, a user interface is displayed 252 (e.g. an image either in motion or still of the user speaking or an avatar of the user or some other object such as a teddy bear), optionally with text or audio outputs. In the communications mode of some embodiments, there are two sub-modes, fixed or free format. In a fixed sub-mode, the communications to the user occur based upon the person's legacy from the knowledge base 800 without user input or control. In a free sub-mode, the communications to the user occur based upon the person's legacy from the knowledge base 800 under control of the user. For example, the user might say or type something like “what time of day were you born” to elicit a response from the knowledge base 800 as spoken by the image/avatar.

A test of the sub-mode 254 is made and if the sub-mode 254 is not free, a sub-loop is performed in which information is loaded 260 from the knowledge base 800, processed 262, and then outputted 264, for example, through speech, text, text bubbles, video; with or without animation of the image or avatar when present. In this, it is anticipated that, in some embodiments, there be a script within the knowledge base 800, the script driving which piece of knowledge from the knowledge base 800 is loaded 260. It is also anticipated that some level of randomization of what is loaded 260 be performed.

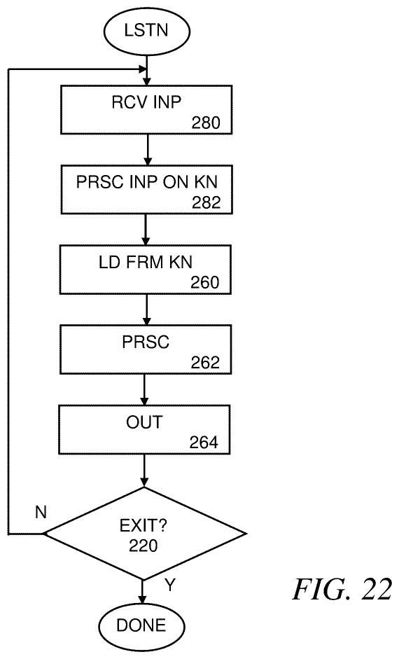

If, after the test of the sub-mode 254 is made, if the sub-mode 254 is free, a different sub-loop (see FIG. 22) is performed in which information is received 280 from the user such the user saying or typing a question or comment (e.g., “saying “what time were you born?”). The received information is then processed 282 with respect to the knowledge base 800 providing context to the question or comment (e.g., if the last output was “I loved pizza,” then if the user says, “what was your favorite,” the context would understand that the user wants to know the person's favorite type of pizza). After the processing 282 understands the question or comment, information is loaded 260 from the knowledge base 800, processed 262, and then outputted 264, for example, through speech, text, text bubbles, video, with or without animation of the image or avatar when present. For example, an avatar of the person might say, “pepperoni pizza,” and in some embodiments, if there is an image or video of the person eating a pepperoni pizza, the output might be embellished with part or all of the image or video to add realism.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction, and arrangement of the components thereof without departing from the scope and spirit of the invention or without sacrificing all of its material advantages. The form herein before described being merely exemplary and explanatory embodiment thereof. It is the intention of the following claims to encompass and include such changes.

1. A method for communicating with loved ones, the method comprising:
initializing a knowledge base;
during a learning mode that is during a life of a person, a computer system receiving information about the person from a computer of the person, the computer system processing the information into knowledge about the person, and the computer system storing the knowledge in the knowledge base; and
after the life of the person, entering a communications mode in which the computer system extracting a portion of the knowledge from the knowledge base, the computer system processing the portion of the knowledge into an output format and the computer system outputting the output format.

2. The method of claim 1, wherein the output format comprises an avatar of the person displayed on a monitor and audio emitted from an audio transducer.

3. The method of claim 2, wherein the avatar of the person is animated.

4. The method of claim 1, wherein receiving the information about the person comprises receiving voice input.

5. The method of claim 1, wherein receiving the information about the person comprises receiving text input about the person.

6. The method of claim 1, wherein receiving the information about the person comprises receiving a file, the file containing an item about the person selected from a list comprising a data file, an image file, and a video file.

7. A system for communicating with loved ones, the system comprising:
a computer having a processor, a display, an audio transducer, and an input device;
a persistent storage operatively coupled to the computer and accessible by the processor;
a knowledge base stored in the persistent storage;
the processor configured to receive information from a person while the person is alive, the information is about a person, and the information comes from the input device; the processor is configured to process the information using learning algorithms implemented with artificial intelligence to create knowledge about the person; and
the processor is configured to store the knowledge in the knowledge base.

8. The system of claim 7, wherein the processor is further configured to extract a portion of the knowledge from the knowledge base and process the portion of knowledge into an output format and then to output the output format to the display and/or audio transducer after the person has died.

9. The system of claim 8, wherein the output format comprises an avatar of the person displayed on the display and audio emitted from the audio transducer.

10. The system of claim 9, wherein the avatar of the person is animated.

11. The system of claim 7, wherein the input device is a microphone and the information about the person is received by the processor from audio received by the microphone, the audio containing the information about the person.

12. The system of claim 7, wherein the input device is a keyboard and the information about the person is received by the processor from text entered at the keyboard, the text comprises the information about the person.

13. The system of claim 7, wherein the information about the person is received by the processor by receiving a file, the file containing an item about the person selected from a list comprising a data file containing the information about the person, an image file containing the information about the person, and a video file containing the information about the person.

14. A system for communicating with loved ones, the system comprising:
a computer having a processor, a display operatively interfaced to the processor, an audio transducer operatively interfaced to the processor, and an input device operatively interfaced to the processor;
a device having a second processor, a second display, the device communicatively interfaced to the computer by a data network;
a persistent storage operatively coupled to the computer and accessible by the processor;
a knowledge base stored in the persistent storage;
computer instructions stored in the persistent storage, the computer instructions cause the processor to receive information about a person from the device and to process the information using learning algorithms implemented with additional computer instructions configured to implement artificial intelligence, the computer instructions cause the processor to create knowledge about the person; and
the computer instructions cause the processor to store the knowledge in the knowledge base.

15. The system of claim 14, wherein the computer instructions cause the processor to extract a portion of the knowledge from the knowledge base and to process the portion of the knowledge into an output format and then the computer instructions cause the processor to output the output format on the display.

16. The system of claim 15, wherein the output format comprises an avatar of the person and the computer instructions cause the processor to display the avatar on the display and to emit audio to the audio transducer.

17. The system of claim 15, wherein the computer instructions receive a further input and the computer instructions cause the processor to process the further input against the knowledge base and extract a portion of the knowledge from the knowledge base related to the further input and to process the portion of the knowledge into the output format and then the computer instructions cause the processor to output the output format.

18. The system of claim 14, wherein the input device is a microphone and the information about the person is received by the processor from audio received by the microphone, the audio containing the information about the person.

19. The system of claim 14, wherein the input device is a keyboard and the information about the person is received by the processor from text entered at the keyboard, the text containing the information about the person.

20. The system of claim 14, wherein the information about the person is received by the processor by receiving a file, the file containing an item about the person selected from a list comprising a data file, an image file, and a video file; whereas the information about the person is in the file.
